(19) United States
(12) Patent Application Publication
(10) Pub. No.: US 2008/0023937 A1
(43) Pub. Date: Jan. 31, 2008

(54) Self-centering boat loading device

(76) Inventor: Charles E. Bryant, Gold Bar, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/484,352

(22) Filed: Jul. 10, 2006

(51) Int. Cl. B60P 3/10

(52) U.S. Cl. 280/414.1

(57) ABSTRACT

A boat centering device for a trailer, the device having a lever arm with a contact member mounted on one end and an outrigger mounted on the other, the lever arm adapted to rotate towards the center of the trailer when the contact member is contacted by a boat. The outrigger urges the boat to the center of the trailer and does not contact the boat once the boat is centered. Matched pairs of lever arms are attached at various points on the trailer to cooperate in centering the bow and stern of the boat.

### BACKGROUND OF THE INVENTION

1. Field of the Invention

The present invention pertains to trailers for boats and, more particularly, to a device for loading a boat on a boat trailer that automatically centers the boat on the trailer during the loading operation and is adaptable to existing trailers.

2. Description of the Related Art

Most recreational boats are stored and transported on a trailer that is towed by a personally owned vehicle. Proper positioning of the boat on the trailer is critical to the safe movement of the trailer on the highways. For example, positioning the boat too far to the rear of the trailer will cause the trailer to fishtail and it will raise the rear end of the tow vehicle, reducing traction from the tow vehicle wheels. Positioning the boat too far forward on the trailer will cause too much weight on the hitch, which will drag the rear of the tow vehicle down and make steering more difficult.

Lateral positioning of the boat on the trailer is also critical, not only for safe transportation and launching and recovery, but also for protecting the hull of the boat. As shown in FIG. 1, most trailers 100 typically have a longitudinal center rail 102 on which are mounted keel rollers 104 for supporting the keel of a boat. The trailer 100 also includes side rails 106, generally parallel to the center rail 102. The side rails 106 typically have bunks 108 or rollers (not shown) or a combination of bunks 108 and rollers for cushioning and stabilizing the boat hull. The exact configuration of the trailer will depend on the type of boat hull.

In some cases, an all-roller trailer is useful for boats having a center keel and left and right sponsons. Alignment of the sponsons with the cradle rollers on the side rails is important to properly support the boat and avoid damage to the hull.

Loading a keel roller trailer requires some skill and agility. With the boat floating near a dock, the trailer is positioned in the water so that the boat and the trailer have their longitudinal axes in general alignment. A winch line is attached to the bow eye on the bow of the boat and the boat is winched onto the trailer with the rollers supporting most or the entire load of the boat. Ideally the boat will remain in alignment with the center rollers. However, wind and waves can cause a boat to easily move off the rollers, requiring quick continual action on the part of those loading the boat. Under less than ideal conditions, this will be a difficult task for an individual to perform alone.

Recently, a new style of trailer has been designed that consists of only bunks and no rollers. In some of these designs, a single vestigial keel roller is located at the stern end of the trailer to deflect the boat upward onto the bunks when loading. Once the boat is fully winched onto the trailer, the stern of the boat no longer contacts the keel roller. Thus, the entire weight of the boat is supported on the bunks and not on the rollers. One disadvantage of this design is that the bunks provide little support for the transom area where the greatest weight of the boat is found, i.e., the engine and fuel. This can place a substantial amount of load on the hull of the boat, which functions as a cantilever to hold up the transom. Because the low-profile trailers are almost completely submerged, the boats are essentiality floated onto the trailer. There is little or no winching of the boat up the trailer because of the substantial friction that would result between the boat hull and the carpeted bunks. Lateral and longitudinal alignment of the boat on the trailer is sometimes more difficult with the float-on trailer design.

Numerous designs have been proposed to assist in loading a boat onto a trailer so that the boat is centered with respect to the trailer, both longitudinally and laterally. For example, U.S. Pat. No. 3,077,277 describes a boat trailer that includes a central roller and a pair of outside rollers that are supported on angularly shaped members that are pivoted on pivot pins. Distal rollers are described as being held in a down position against the trailer by weight and are pushed into engagement with the boat hull as the boat keel bears down on a roller that joins two mutually-opposed arms. Because these arms are coupled together through the single roller, the keel of the boat must bear down on the central roller in order to activate the arms. Hitting only one of the arms will not cause either of the arms to move the hull to a centered position.

In U.S. Pat. No. 4,138,135, a boat trailer is described having a wheeled frame with a tongue extending from a forward end thereof. A boat support is provided on the frame between the opposing sides for supporting the bottom portion of a boat. A pair of spaced-apart arms is pivotally secured to the frame at one side thereof and extends upwardly. A guide rail is secured to and extends between the upper ends of the pair of arms for engagement with one side of the boat. A spring is connected to each of the arms for yieldably urging the guide rail towards the center of the trailer and into engagement with the side of the boat. A second pair of arms is secured to the frame on the other side thereof and extends upwardly therefrom with a second guide rail secured to the upper ends thereof. Thus, the pair of arms in this design are pivotally mounted on the trailer frame and biased towards the center of the trailer by undercarriage springs at a free end of the arms. Hence, a boat loading onto this trailer will contact the arms along the side of the hull and scrape against the guide rails as the boat is being winched onto the trailer. In addition, the guide rails remain in contact with the boat as the boat is being transported, causing wear and chafing on the boat hull.

Hence, there is a need for a mechanically-simple device that automatically centers a boat on a trailer without causing damage to the hull and that is easily adaptable to existing trailers.

### BRIEF SUMMARY OF THE INVENTION

A boat centering device and assembly are provided in the disclosed embodiments of the invention described herein. In one embodiment of the invention, a boat centering device for a trailer is provided. The device includes a lever arm having a first end and a second end, the lever arm adapted to be mounted on a mount on the trailer. Ideally, the lever arm rotates about an axis substantially parallel to the longitudinal axis of the trailer. A contact member is mounted on the first end of the lever arm and configured to be contacted by the boat, and an outrigger is mounted on the second end of the lever arm, the outrigger adapted to urge the boat towards the longitudinal axis of the trailer when the contact member is in contact with the boat and to not contact the boat when the boat is centered on the trailer. Ideally, a biasing member is adapted to rotate the lever arm in a direction that will move the contact member upward when the contact member is not in contact with the boat hull. In accordance with an aspect of the forgoing embodiment, the biasing member includes a torsion spring.

In accordance with a further aspect of the forgoing embodiment, the contact member includes a support post having a first end adapted for attachment to the first end of the lever arm and a second end adapted for attachment to a bumper, the bumper mounted at an angle on the support post.

In accordance with another aspect of the forgoing embodiment, the outrigger includes a bumper having a first side adapted for attachment to the outrigger and a second side adapted for contact with the boat. Ideally, the bumper includes wedges adapted to expand and contract.

In accordance with yet a further aspect of the forgoing embodiment, the support post is adjustable in length.

In accordance with yet another aspect of the forgoing embodiment, a length between the mount and the first end of the lever arm is a first length and a length between the second end of the lever arm and the mount is a second length, and the first length is greater than the second length. Ideally, the first length and the second length are independently or dependently adjustable.

In another embodiment of the invention, a boat centering assembly for a trailer is provided. The assembly includes at least two independent lever arms, each lever arm having a first end and a second end, the lever arms adapted to rotate in a plane that is perpendicular to the longitudinal axis of the trailer; at least two bearing members on the first end of each lever arm and configured to rotate the lever arm when contacted by the boat hull; at least two outriggers mounted on the second end of each lever arm and configured to urge the boat towards the center of the trailer when each lever arm rotates in a first direction; and a respective biasing member associated with each lever arm that biases each lever arm to rotate in a second direction to move the outrigger away from the boat hull when the boat is centered on the trailer. Ideally, the biasing member includes a torsion spring.

In accordance with a further aspect of the forgoing embodiment, the at least two bearing members include a support post having a first end adapted for attachment to the first end of the lever arm, and a second end adapted for attachment to a bumper, the bumper mounted at an angle on the support post.

In yet another embodiment of the invention, a method for centering a boat on a trailer is provided. The method includes biasing a lever arm in a first position away from the center of the trailer; moving the boat closer to the trailer so that the lever arm rotates a second end of the lever arm away from the first position to a second position towards the boat to center the boat with respect to the trailer; and fully resting the boat in a laterally centered position on the trailer and in contact with the first end of the lever arm (e.g., via a contact member) and not in contact with the second end of the lever arm.

In accordance with a further embodiment of the invention, a boat centering assembly for a trailer is provided. The assembly includes a device for rotating about an axis substantially parallel to the longitudinal axis of the trailer; a device for contacting the boat, the contacting device mounted on the rotating device; and a device for urging the boat towards the longitudinal axis of the trailer when the contacting device is in contact with the boat and to not contact the boat when the boat is centered on the trailer, the urging device mounted on the rotating device.

In accordance with a further aspect of the forgoing embodiment, a device is provided for biasing the urging device in a direction that will move the contacting device upwards when the contacting device is not in contact with the boat. Ideally, the biasing device includes a torsion spring.

In accordance with yet a further aspect of the forgoing embodiment, the contacting device includes a support post having a first end adapted for attachment to the first end of the lever arm, and a second end adapted for attachment to a bumper, the bumper mounted at an angle on the support post.

In another embodiment of the invention, an improved boat trailer is provided, the boat trailer having a frame, at least one cross member, at least one bunk mounted to the at least one cross member, at least one axle, a plurality of wheels attached to the at least one axle, a hitch assembly attached to the frame is provided. The improvement includes at least two lever arms, each lever arm having a first end and a second end. Preferably, the lever arms are adapted to rotate in a plane that is substantially perpendicular to the longitudinal axis of the trailer. The improvement further includes at least one bearing member, on the first end of each lever arm, and configured to rotate the lever arm when contacted by the boat hull; at least one outrigger mounted on the second end of each lever arm and configured to urge the boat towards the center of the trailer when each lever arm rotates in a first direction; and a respective biasing member associated with each lever arm that biases each lever arm to rotate in a second direction to move the outrigger away from the boat hull when the boat is centered on the trailer.

In yet a further embodiment of the invention, a kit that adapts a boat trailer to self-center a boat hull on the trailer is provided. The kit includes at least two lever arms adapted for pivotal connection to the trailer to move independently about an axis that is substantially parallel to a longitudinal axis of the trailer, each lever arm having at least one mounting opening, a first end, and a second end; a first contact member adapted for attachment to the first end of the lever arm and structured for contact with a bottom of the boat hull; a second contact member adapted to be attached to the second end of the lever arm and structured to bear against a side of the boat hull; and a mounting assembly for mounting each lever arm independently to the trailer frame, the mounting assembly including a biasing member for urging the lever arm to independently rotate in a direction that moves the second contact member away from a longitudinal axis of the trailer.

In accordance with a further aspect of the forgoing embodiment, the mounting assembly includes at least one axle for each of the at least two lever arms, the axle adapted to be attached to the trailer and to receive the mounting opening of the corresponding lever arm, and the biasing member comprising a torsion spring. Ideally, a retaining member is provided for each of the at least two lever arms and adapted to hold each lever arm in a position where the lever arm is rotated towards the longitudinal axis of the trailer.

In accordance with yet another aspect of the forgoing embodiment, a distance between the first end and the mounting opening includes a first length and a distance between the second end and the mounting opening includes a second length, wherein the first length is greater than the second length.

As will be readily appreciated form the foregoing, the disclosed embodiments of the present invention provide a new device for centering a boat on a trailer frame and correct the issues listed above. In particular, the lever arm is biased to rotate the outrigger outward and away from the boat hull. The outrigger does not contact the boat when the boat is centered on the trailer. This feature prevents scraping along the boat hull when the boat is being loaded on the trailer and further prevents damage to the hull during transport.

The device is also designed to accommodate boat hulls of various shapes and sizes. In particular, the length of the lever arm and the contact member may be adjustable and further provide the lever arm the ability to achieve a greater mechanical advantage when the boat hull shape and size allow.

Additionally, the device is easily adaptable to existing trailers. In accordance with one embodiment of the invention, the device is provided in a kit that allows installation of the device to any conventional boat trailer. This embodiment further allows the user to choose the number of devices to install based on preference and the shape and size of the boat. Thus the new design provides improved flexibility while providing effective centering of a boat on a trailer.

### BRIEF DESCRIPTION OF THE SEVERAL VIEWS OF THE DRAWING(S)

FIG. 1 is an isometric view of a conventional boat trailer.

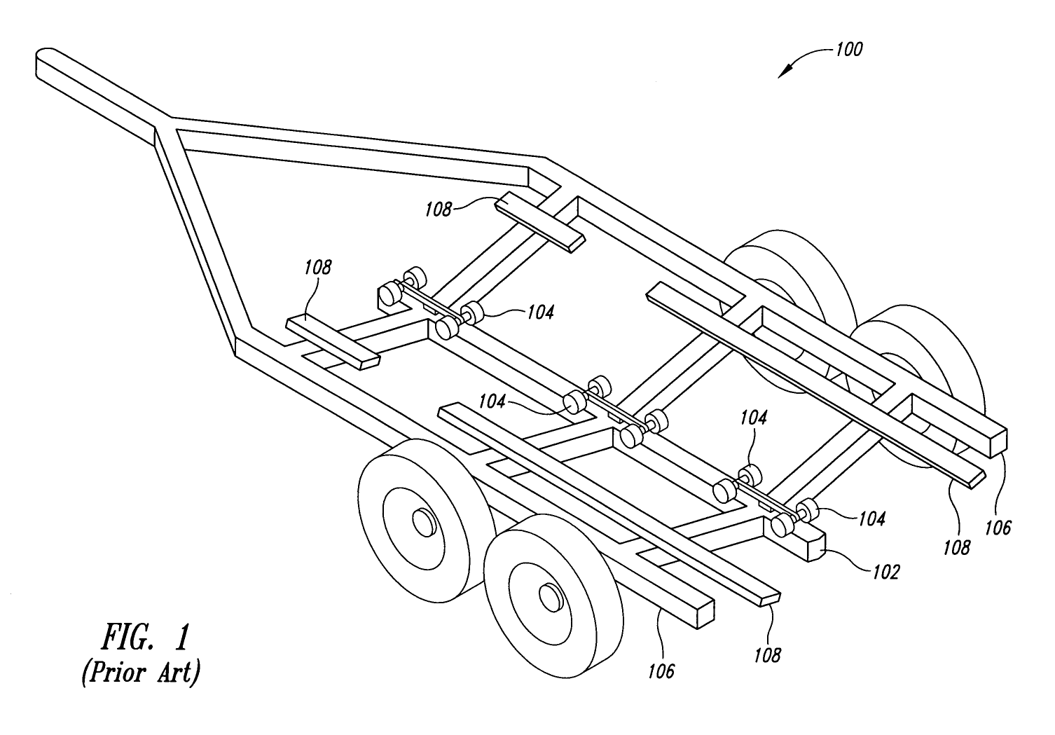

FIG. 2 is a top view of a conventional boat trailer modified to include a boat centering assembly formed in accordance with one embodiment of the invention.

FIGS. 3A-3B are end views of a conventional trailer adapted to include a boat centering assembly, in accordance with one embodiment of the invention, when the boat is floating above the trailer and when the boat is fully rested on the trailer respectfully.

FIG. 4 is a side view of a boat centering device formed in accordance with one embodiment of the present invention.

FIG. 5 is a side view of an outrigger formed in accordance with one embodiment of the invention.

FIG. 6 is a side view of a contact member attached to a lever arm.

FIG. 7 is a top view of a lever arm and corresponding mounting assembly according to one embodiment of the invention.

FIG. 8A is a top view of a safety device attached to a mount in accordance with one embodiment of the invention.

FIG. 8B is a side view of the safety device attached to a mount in accordance with one embodiment of the invention.

### DETAILED DESCRIPTION OF THE INVENTION

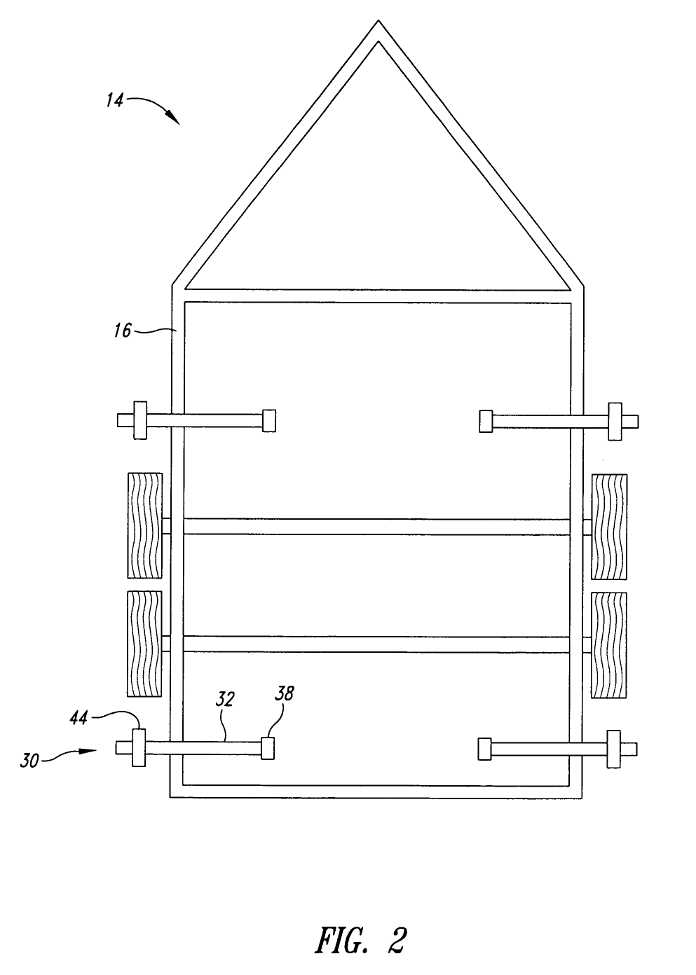

A representative embodiment of the present invention will now be described in conjunction with FIGS. 2-8. FIG. 2 shows a boat trailer 14 with a trailer frame 16 modified to include a boat centering assembly 30, according to one embodiment of the invention. The boat centering assembly 30 includes four of the devices 30 mounted on opposite sides of the trailer frame 16. The front two devices 30 ensure centering of the bow while the rear two devices 30 ensure centering of the stern. It is preferred, in one embodiment, that for boats sixteen feet and longer, at least four of the devices 30 be used in order to ensure efficient centering of the boat 10 on the trailer 14. However, it is understood that any number of the device 30 will center the boat 10. For example, a single device 30, an assembly of at least two devices 30, or an assembly of four or more devices 30 can all be used, depending on the type of boat 10, the size of the trailer 14, and user preference.

In one embodiment, the boat centering device 30 may be in a kit form to adapt a trailer 14 to become self-centering. In another embodiment, the boat centering device 30 may be manufactured as an integral component of the trailer 14.

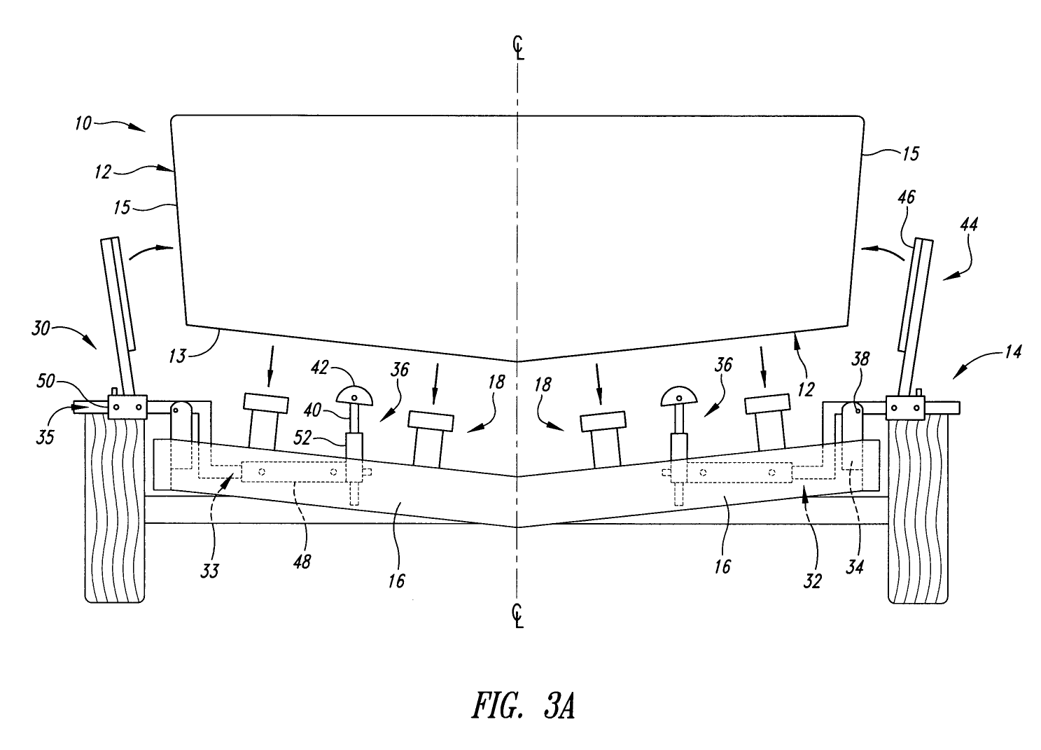

FIG. 3A and FIG. 3B show one embodiment of the invention where a boat centering assembly 30 is used on the boat trailer 14 to guide the boat 10 having a hull 12 onto the trailer 14. In FIG. 3A, the boat 10 is floating above the trailer 14 in water. In FIG. 3B, the boat 10 is fully resting on the bunks 18. The boat centering assembly 30 includes at least two lever arms 32 that are mounted to the trailer 14. Preferably, each lever arm 32 rotates in a plane that is approximately perpendicular to the longitudinal axis of the trailer 14 and towards the center of the trailer frame 16. Contact members 36 are attached to a first end 33 of each lever arm 32 while outriggers 44 are mounted on a second end 35. When a bottom 13 of the boat hull 12 bears against the contact member 36, the lever arm 32 will rotate. The second end 35 of each lever arm 32 is thus rotated towards the center of the trailer 14 so that the outriggers 44 move towards each other, and at least one of the outriggers 44 will contact a side 15 of the hull 12 to urge the boat 10 towards the center of the trailer 14. In other words, when the boat 10 is positioned off center and towards one side of the trailer 14, the outrigger 44 on that side of the trailer 14 will contact the hull 12 and urge the hull 12 to move back towards the center of the trailer 14.

Biasing members 38 are associated with each lever arm 32 to bias the lever arms 32 to rotate the outriggers 44 away from each other. Ideally, in one embodiment, the outriggers 44 are configured to not contact the boat hull 12 when the boat 10 is centered and resting on the trailer 14. For example, when the boat 10 is centered and resting on the trailer 14, each outrigger 44 will be spaced away from the side of the boat hull 12 a distance in the range of ¾ inch to 1.5 inches, and preferably about one inch. Thus, for a hull that is 79 inches in width, the outriggers will be separated approximately in the range of 80.5 inches to 82 inches and preferably about 81 inches. This will prevent rubbing of the outrigger 44 against the hull 12 while in transport.

In one embodiment, the biasing members 38 rotate the lever arms 32 in such a direction as to cause the outriggers 44 to move away from the center of the trailer 14 and over the edge of the trailer frame 16 when the boat 10 is not in contact with the contact members 36. Preferably, the outriggers 44 are angled away from the boat 10 at about eighteen degrees from the vertical edge of the trailer frame 16. However, it is understood that other angles may be used.

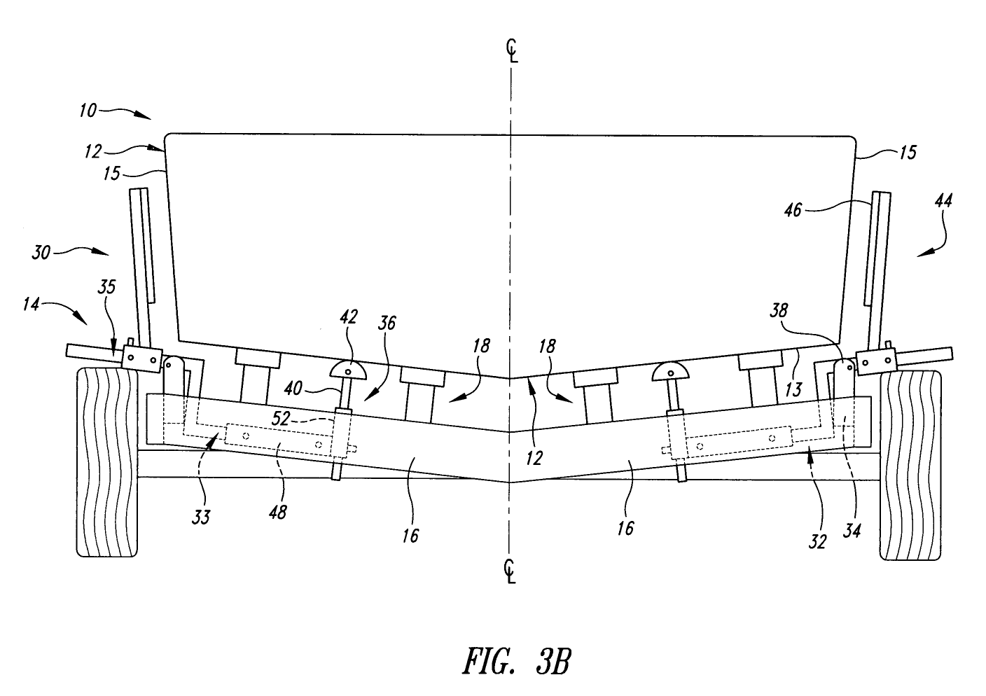

In accordance with another embodiment of the invention, FIG. 4 illustrates a side view of the boat centering device 30. The device 30 includes a lever arm 32 mounted on a mount 34 on the trailer 14. Ideally the lever arm 32 will rotate about an axis that is approximately parallel to the longitudinal axis of the trailer 14. However, it is to be understood that the lever arm 32 can rotate on an axis having a different orientation to achieve a different mechanical advantage or to accommodate boat and trailer designs. An outrigger 44 is mounted on the second end 35 of the lever arm 32, while the contact member 36 is mounted on the first end 33. In one embodiment, the lever arm 32 includes a mounting opening to receive a mounting assembly for mounting the lever arms independently to the trailer frame. Ideally, in the foregoing embodiment, the mounting assembly includes at least one axle (not shown) that attaches to the trailer and receives the mounting opening. In another embodiment, the lever arm 32 is formed to correspond to the shape of the trailer frame 16. Here, the lever arm 32 comprises three bars 27, 29, and 31 joined together to be positioned around the trailer frame 16 without contacting the trailer frame 16. The lever arm 32 pivots on the mount 34, as shown in FIG. 4. Ideally, the lever arm 32 is formed of steel, although it is understood that other material may be used, such as plastic or aluminum. The material is treated to withstand corrosion from either or both salt water and fresh water.

In yet another embodiment, the lever arm 32 includes an adjustment bar 48 that adjusts the location of the contact member 36 and an adjustment bar 50 that adjusts the location of the outrigger 44. The adjustment bars 48 and 50 are slidably engaged over the respective first and second ends 33, 35 of the lever arm 32 and retained in place by suitable fasteners 49 to allow the device 30 to accommodate boats of various shapes and sizes.

In FIG. 4, the outrigger 44 is adapted to urge the boat 10 towards the center of the trailer 14 when the boat 10 is in contact with the contact member 36. The outrigger 44 is also adapted to maintain a distance of separation from the boat hull 12 when the boat 10 is centered on the trailer 14 and resting on the bunks 18, as shown in FIG. 3B. The distance of separation is important because it ensures that the hull 12 is not damaged in transport, by the outriggers 44.

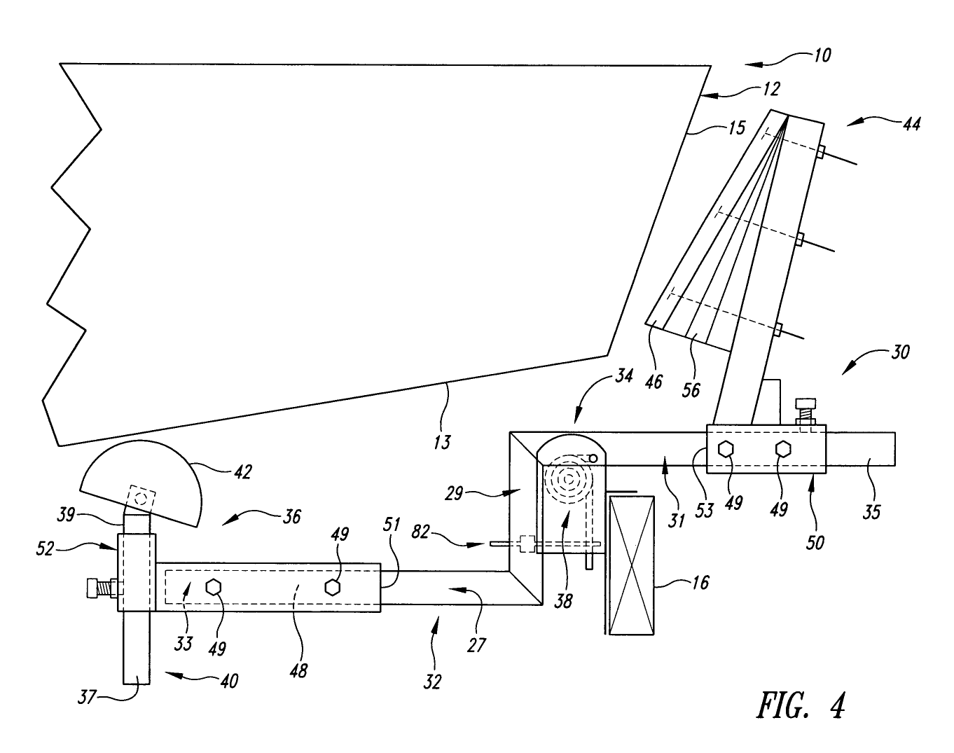

As shown in FIG. 4 and again in FIG. 5, the outrigger 44 includes a bumper 46 preferably formed of plastic, although other materials can be used. In one embodiment, the outrigger 44 includes adjustable wedges 56 that are configured to have adjustable dimensions, such as by expansion and contraction, to accommodate boat hulls of various shapes and sizes.

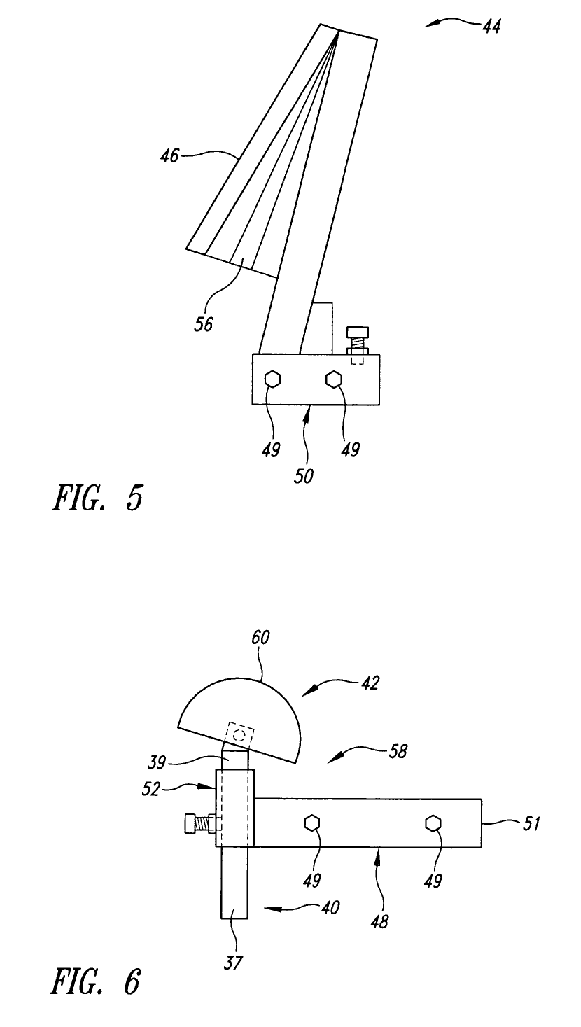

In FIG. 4, contact members 36 preferably include a support post 40 that attaches to the lever arm 32 at one end 37 and have a bumper 42 attached at the other end 39, as shown in FIGS. 4 and 6. The bumper 42 is preferably formed of polyethylene and has a rectangular base 58 with a curved head 60. As shown in FIG. 6, the bumper 42 is preferably mounted to have a fixed angle laterally with respect to the longitudinal axis of the support post 40. The preferred shape and position of the bumper 42 allows the device 30 to accommodate the chine of the boat 10 without causing damage to the boat hull 12 during movement of the hull 12 or by constraining movement of the boat 10 on the trailer 14. However, other methods of support can be used for the contact member 36, such as a nonadjustable post without a bumper or a support post with a bumper of a different shape, for example, one that includes a square or triangular head. In one embodiment, the support post 40 also includes an adjustment bar 52 that varies the length of the support post 40 in order for the device 30 to adapt to different sizes and shapes of trailers and boat hulls.

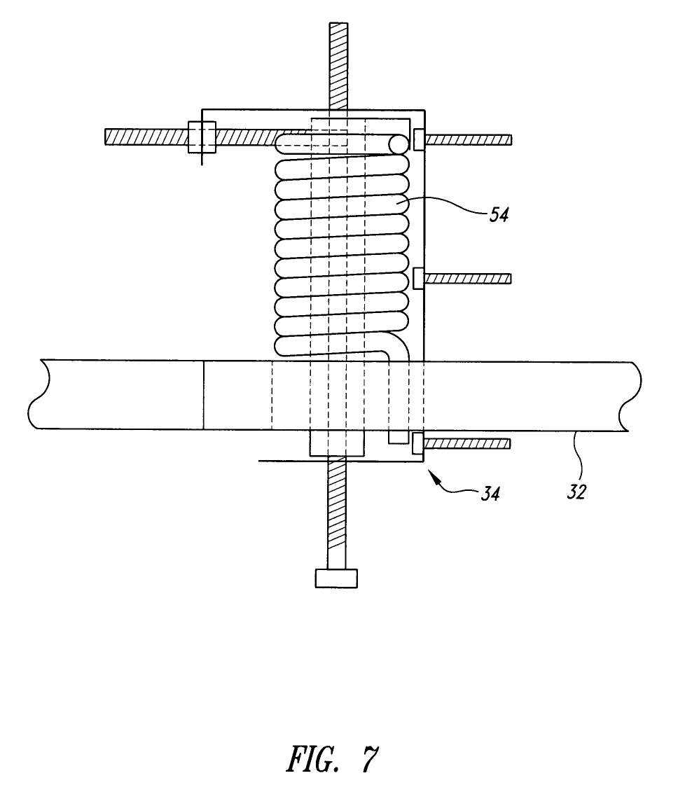

As further shown in FIG. 4, in one embodiment, the biasing member 38 is also associated with the device 30. The biasing member 38 rotates the lever arm 32 in a direction that will move the contact member 36 upward when the boat hull 12 is not in contact with the contact member 36. For example, the contact member 36 will move upward when the device 30 is not in use or when the boat 10 is floating above the device 30 and has not yet come to rest on the trailer 14. It is preferred that the biasing member 38 include a torsion spring 54, as shown in FIG. 7. However, it is understood that other methods for biasing may be used that are known to those skilled in the art. In one embodiment, the biasing member 38 is housed within the mount 34 while the mount 34 is attached to the lever arm 32 and the trailer frame 16, as shown in FIG. 4.

In order for the lever arm 32 to achieve the greatest mechanical advantage, it is preferred that the length between the mount 34 and the contact member 36 on the first end 33 be greater than the length between the mount 34 and the outrigger 44 on the second end 35. To this end, it is preferred to construct the lever arm 32 such that the distance between the mount 34 and the proximal end 51 of the adjustment bar 48 is greater than the distance between the mount 34 and the proximal end 53 of the adjustment bar 50. The adjustment bars 48 and 50 can further be used to adjust the ratio of the two lengths in order to achieve an even greater mechanical advantage when the shape and size of the boat 10 allow. However, it is understood that other alternative methods of determining the ratio can be used, such as using a lever arm that is completely adjustable in length.

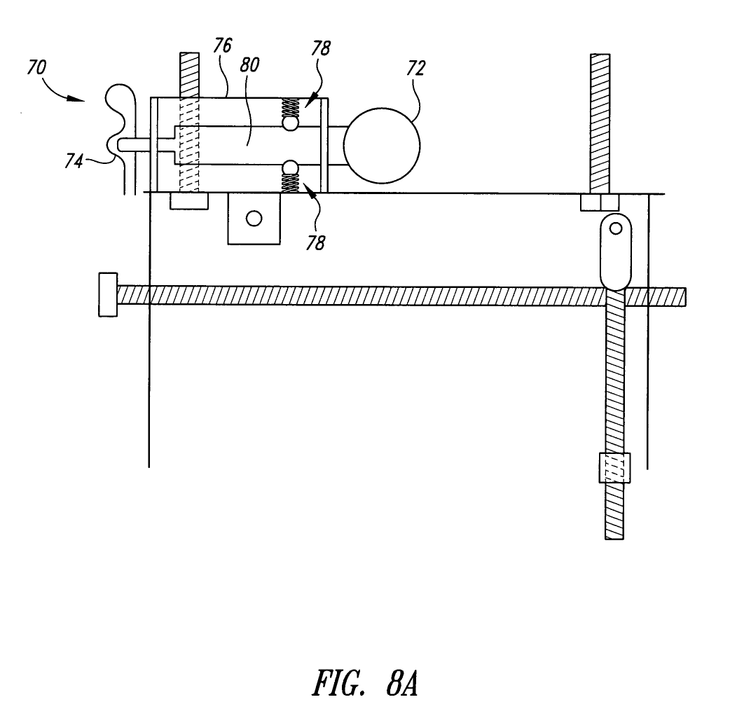

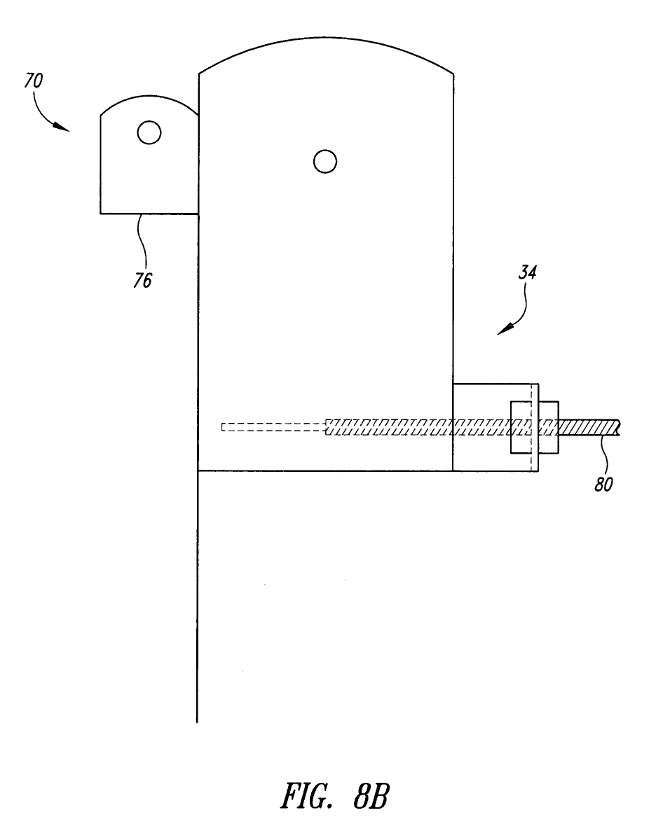

FIG. 8A illustrates a safety device in accordance with another embodiment of the invention. The safety device 70 includes a detent pin 80 having a double failsafe key ring 72 and pin 74. The detent pin 80 is used to secure the lever arm 32, and thus the outrigger 44, in a position where the lever arm 32 and the outrigger 44 are rotated towards the center of the trailer 14. In the embodiment where the biasing member 38 rotates the lever arm 32 in such a direction as to cause the outrigger 44 to move away from the center of the trailer 14 and over the edge of the trailer frame 16, the safety device 70 is used to store the outrigger 44 in a position that will cause the outrigger 44 to remain within the boundary of the trailer frame 16, and thus prevent damage to the outrigger 44 and to objects that the outrigger 44 may hit. In one embodiment, a detent ball 78 is used to secure the position of the detent pin 80. In yet another embodiment, the safety device 70 is encased in a housing 76 and attached to the mount 34, as shown in FIG. 8B.

In construction, the various components of the device 30 are preferably attached together using either conventional bolts, tension bolts, or welded together to form a rigid structure. However, it is to be understood that other methods of attachment may be used, including fasteners, tightly-fitted joints, and other methods known to those skilled in the art.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A boat centering device for a trailer, comprising:
a lever arm having a first end and a second end, the lever arm adapted to be mounted on a mount on the trailer to rotate about an axis substantially parallel to the longitudinal axis of the trailer;
a contact member mounted on the first end of the lever arm and configured to be contacted by the boat; and
an outrigger mounted on the second end of the lever arm, the outrigger adapted to urge the boat towards the longitudinal axis of the trailer when the contact member is in contact with the boat and to not contact the boat when the boat is centered on the trailer.

2. The device of claim 1, further comprising a biasing member adapted to rotate the lever arm in a direction that will move the contact member upward when the contact member is not in contact with the boat hull.

3. The device of claim 2 wherein the biasing member includes a torsion spring.

4. The device of claim 1 wherein the contact member comprises a support post having a first end adapted for attachment to the first end of the lever arm, and a second end adapted for attachment to a bumper, the bumper mounted at an angle on the support post.

5. The device of claim 4 wherein the support post is adjustable in length.

6. The device of claim 1 wherein a length between the mount and the first end of the lever arm comprises a first length and a length between the second end of the lever arm and the mount comprises a second length, the first length is greater than the second length.

7. The device of claim 6 wherein the first length is adjustable and the second length is adjustable.

8. The device of claim 1 wherein the outrigger includes a bumper having a first side adapted for attachment to the outrigger and a second side adapted for contact with the boat.

9. The device of claim 8 wherein the bumper comprises at least one wedge adapted to expand and contract in size.

10. A boat centering assembly for a trailer, comprising:
at least two independent lever arms, each lever arm having a first end and a second end, the lever arms adapted to rotate in a plane that is substantially perpendicular to the longitudinal axis of the trailer;
at least two bearing members on the first end of each lever arm and configured to rotate the lever arm when contacted by the boat hull;
at least two outriggers mounted on the second end of each lever arm and configured to urge the boat towards the center of the trailer when each lever arm rotates in a first direction; and
a respective biasing member associated with each lever arm that biases each lever arm to rotate in a second direction such that the outrigger does not contact the boat hull when the boat is centered on the trailer.

11. The assembly of claim 10 wherein the biasing member includes a torsion spring.

12. The assembly of claim 10 wherein the at least two bearing members include a support post having a first end adapted for attachment to the first end of the lever arm, and a second end adapted for attachment to a bumper, the bumper mounted at an angle on the support post.

13. A method for centering a boat on a trailer, comprising:
biasing a lever arm in a first position away from the center of the trailer;
moving the boat closer to the trailer so that the lever arm rotates a second end of the lever arm away from the first position to a second position towards the boat to center the boat with respect to the trailer; and
fully resting the boat in a laterally centered position on the trailer and in contact with the first end of the lever arm and not in contact with the second end of the lever arm.

14. A boat centering assembly for a trailer, comprising:
means for rotating about an axis substantially parallel to the longitudinal axis of the trailer;
means for contacting the boat, the contacting means mounted on the rotating means; and
means for urging the boat towards the longitudinal axis of the trailer when the contacting means is in contact with the boat and to not contact the boat when the boat is centered on the trailer, the urging means mounted on the rotating means.

15. The assembly of claim 14, further comprising means for biasing the urging means in a direction that will move the contacting means upwards when the contacting means is not in contact with the boat.

16. The assembly of claim 15 wherein the biasing means comprises a torsion spring.

17. The assembly of claim 14 wherein the contacting means comprises a support post having a first end adapted for attachment to the first end of the lever arm, and a second end adapted for attachment to a bumper, the bumper mounted at an angle on the support post.

18. A boat trailer, the trailer having a frame, at least one cross member, at least one bunk mounted to the at least one cross member, at least one axle, a plurality of wheels attached to the at least one axle, a hitch assembly attached to the frame, the improvement comprising:
at least two lever arms, each lever arm having a first end and a second end, the lever arms adapted to rotate in a plane that is substantially perpendicular to the longitudinal axis of the trailer;
at least one bearing member on the first end of each lever arm and configured to rotate the lever arm when contacted by the boat hull;
at least one outrigger mounted on the second end of each lever arm and configured to urge the boat towards the center of the trailer when each lever arm rotates in a first direction; and
a respective biasing member associated with each lever arm that biases each lever arm to rotate in a second direction to move the outrigger away from the boat hull when the boat is centered on the trailer.

19. A kit that adapts a boat trailer to self-center a boat hull on the trailer, the kit comprising:
at least two lever arms adapted for pivotal connection to the trailer to move independently about an axis that is substantially parallel to a longitudinal axis of the trailer, each lever arm having at least one mounting opening, a first end, and a second end;
a first contact member adapted for attachment to the first end of the lever arm and structured for contact with a bottom of the boat hull;
a second contact member adapted to be attached to the second end of the lever arm and structured to bear against a side of the boat hull; and
a mounting assembly for mounting each lever arm independently to the trailer frame, the mounting assembly including a biasing member for urging the lever arm to independently rotate in a direction that moves the second contact member away from a longitudinal axis of the trailer.

20. The kit of claim 19 wherein the mounting assembly comprises at least one axle for each of the at least two lever arms, the axle adapted to be attached to the trailer and to receive the mounting opening of the corresponding lever arm, and the biasing member comprising a torsion spring.

21. The kit of claim 20, further comprising a retaining member for each of the at least two lever arms and adapted to hold each lever arm in a position where the lever arm is rotated towards the longitudinal axis of the trailer.

22. The kit of claim 19 wherein a distance between the first end and the mounting opening comprises a first length and a distance between the second end and the mounting opening comprises a second length, and wherein the first length is greater than the second length.
